(19) United States
(12) Patent Application Publication
(10) Pub. No.: US 2020/0003060 A1
(43) Pub. Date: Jan. 2, 2020

(54) TURBINE ELEMENT FOR HIGH PRESSURE DROP AND HEAT TRANSFER

(71) Applicant: Siemens Aktiengesellschaft, München (DE)

(72) Inventors: Jose L. Rodriguez, Longwood, FL (US); Matthew J. Golsen, Orlando, FL (US); John T. Harrington, Fleming Island, FL (US); Stephen Wright, Scottsdale, AZ (US); Gary B. Merrill, Orlando, FL (US)

(21) Appl. No.: 16/465,207

(22) PCT Filed: Jan. 18, 2017
(86) PCT No.: PCT/US2017/013892

§ 371 Date: May 30, 2019

(51) Int. Cl. F01D 5/18

(52) U.S. Cl. CPC F01D 5/188; F05D 2260/22141; F05D 2250/11; F05D 2250/12; F05D 2250/183

(57) ABSTRACT

A turbine element for high pressure drop and heat transfer. The turbine element includes a plurality of elements (16) radially placed in columns together aligned in a series of rows of at least four rows across an interior surface of an outer wall of an airfoil (10), creating a pin fin pattern (14) based on the shape of each of the plurality of elements (16), wherein each element (16) includes an inner length between an inner top edge and an inner bottom edge, an inner width between an inner left edge and an inner right edge. The pin fin pattern (14) is highly packed and fills a portion of the interior surface of the outer wall of the airfoil (10).

### BACKGROUND

### 1. Field

The present invention relates to gas turbine engines and more specifically to a turbine element for high pressure drop and heat transfer.

### 2. Description of the Related Art

In an axial flow industrial gas turbine engine, hot compressed gas is produced. The hot gas flow is passed through a turbine and expands to produce mechanical work used to drive an output shaft, such as in an electric generator for power production. The turbine generally includes multiple stages of stator vanes and rotor blades to convert the energy from the hot gas flow into mechanical energy that drives the rotor shaft of the engine.

A combustion system receives air from a compressor and raises it to a high energy level by mixing in fuel and burning the mixture, after which products of the combustor are expanded through the turbine.

Gas turbines are becoming larger, more efficient, and more robust. Large blades and vanes are being utilized, especially in the hot section of the engine system. In view of high pressure ratios and high engine firing temperatures implemented in modern engines, certain components, such as airfoils, e.g., stationary vanes and rotating blades within the turbine section, must be cooled with cooling fluid, such as air discharged from a compressor in the compressor section, to prevent overheating of the components. When large amounts of cooling occur, however, reduction in efficiency and increases in leakages occur.

Current cooling technology uses orifice plates at the flow inlet. This leads to low pressure in the cooling passages and problems with backflow margins. Further, it does not increase the heat transfer. These features fail to provide the capability to limit the flow to levels that are needed by advanced engines, while maintaining the required heat transfer within the limitations of advanced manufacturing methods.

### SUMMARY

In one aspect of the present invention, a turbine element comprises: a generally elongated airfoil having a leading edge and a trailing edge connected to a pressure side and a suction side defining an outer wall, and a cooling circuit, wherein the cooling circuit comprises: a plurality of elements radially placed in columns together aligned in a series of rows of at least four rows across an interior surface of the outer wall of the airfoil, creating a pin fin pattern based on the shape of each of the plurality of elements, wherein each element comprises: an inner length between an inner top edge and an inner bottom edge, an inner width between an inner left edge and an inner right edge, wherein the pin fin pattern includes pin fin pattern lengths that extend from the inner top edge of one element to the inner top edge of the next element within a column, and pin fin pattern widths that extend from the inner left edge of one element to the inner left edge of an element in the next row, wherein the plurality of elements extend lengthwise in a span-wise direction along the airfoil and extend widthwise in an axial direction, wherein the aspect ratio of inner length over the inner width of each element is equal to or greater than 2:1, wherein the ratio of pin fin pattern lengths over the inner length is equal to or less than 2:1, wherein the ratio of pin fin pattern widths over the inner width is equal to or less than 4:1.

These and other features, aspects and advantages of the present invention will become better understood with reference to the following drawings, description and claims.

### BRIEF DESCRIPTION OF THE DRAWINGS

The invention is shown in more detail by help of figures. The figures show preferred configurations and do not limit the scope of the invention.

FIG. 1 is a mean sectional view of a trailing edge of a blade airfoil according to an exemplary embodiment of the present invention;

FIGS. 2-11 are sample portions of pin fin patterns according to various exemplary embodiments of the present invention;

FIG. 12 is a sample portion of a pattern of an exemplary embodiment of the present invention and the flow paths taken around the pattern; and

FIG. 13 is an exemplary example of a cooling circuit within a blade airfoil within the prior art.

### DETAILED DESCRIPTION

In the following detailed description of the preferred embodiment, reference is made to the accompanying drawings that form a part hereof, and in which is shown by way of illustration, and not by way of limitation, a specific embodiment in which the invention may be practiced. It is to be understood that other embodiments may be utilized and that changes may be made without departing from the spirit and scope of the present invention.

Broadly, an embodiment of the present invention provides a turbine element for high pressure drop and heat transfer. The turbine element includes a plurality of elements radially placed in columns together aligned in a series of rows of at least four rows across an interior surface of an outer wall of an airfoil, creating a pin fin pattern based on the shape of each of the plurality of elements, wherein each element includes an inner length between an inner top edge and an inner bottom edge, an inner width between an inner left edge and an inner right edge. The pin fin pattern is highly packed and fills a portion of the interior surface of the outer wall of the airfoil.

A gas turbine engine may comprise a compressor section (not shown), a combustor (not shown) and a turbine section (not shown). The compressor section compresses ambient air. The combustor combines the compressed air with a fuel and ignites the mixture creating combustion products comprising hot gases that form a working fluid. The working fluid travels to the turbine section. Within the turbine section are circumferential rows of vanes and blades, the blades being coupled to a rotor. Each pair of rows of vanes and blades forms a stage in the turbine section. The turbine section comprises a turbine casing, which houses the vanes, blades and rotor. A blade of a gas turbine receives high temperature gases from a combustion system in order to produce mechanical work of a shaft rotation.

The vane and blade assemblies in the turbine section are exposed to the high temperature working gas as the high temperature working gas passes through the turbine section. Cooling air 30 from the compressor section may be provided to cool the vane and blade assemblies, as will be described herein.

A reduction in component cooling flow and increase in heat transfer is desirable. Embodiments of the present invention provide a pin fin pattern 14 with a high aspect ratio for high pressure drop and high heat transfer. The pin fin pattern 14, as will be discussed in detail below, will provide improved increased heat transfer.

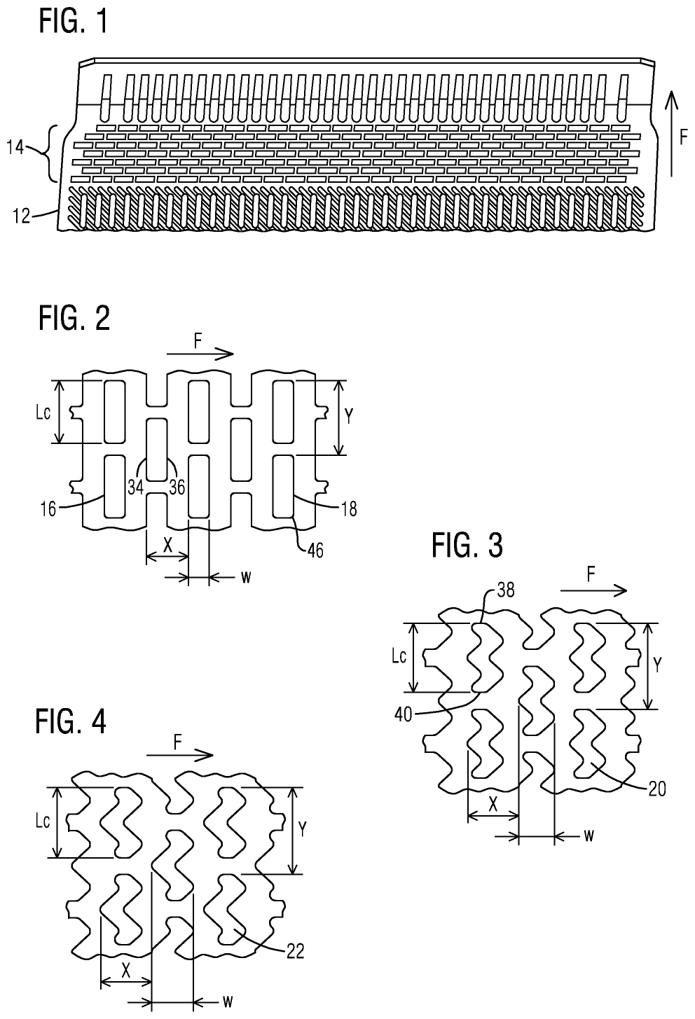

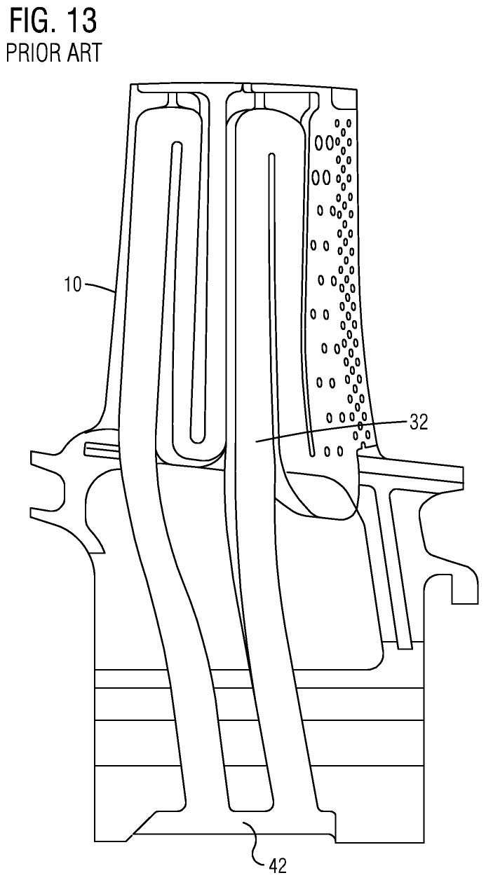

A turbine element such as the blade or the vane includes a generally elongated airfoil 10. The airfoil 10 has a leading edge and a trailing edge 12 that connects to a pressure side and a suction side. A cooling circuit 32 also is included in the airfoil 10 to reduce temperatures to protect the material of the airfoil 10 while in service. The cooling circuit 32 includes a series of paths within the airfoil 10 that allow for cooling air 30 to be introduced into the interior of the airfoil 10 to reduce temperatures. A basic example of the cooling circuit 32 is shown in FIG. 13. FIG. 1 shows a trailing edge 12 of a blade airfoil 10 according to an embodiment of the present invention. The pin fin pattern 14 may be located along an interior surface of an outer wall. The pin fin pattern 14 may be located along the trailing edge wall along the trailing edge 12 and extending from an airfoil cavity 42 to an interior surface of the outer wall. The trailing edge 12 is used as an example of a location for the pin fin pattern 14; the location however, is not exclusive to the trialing edge 12 of the blade. The pin fin pattern 14 may be located wherever high pressure drop and high heat transfer is required, such as in multiwall applications and the like. The details of the cooling circuit 32 are not discussed here, other than the pin fin pattern 14 across an interior surface of an outer wall of the airfoil 10. Aft of a rear boundary of a last channel of the cooling circuit 32 of the blade airfoil 10 is an example of an embodiment of the present invention. The cooling circuit 32 ends with a plurality of elements 16 such as shown in FIG. 1. The figure shows the plurality of elements 16 of the pin fin pattern 14 that runs the radial length of the blade. The pin fin pattern 14 is highly packed with high aspect ratio features.

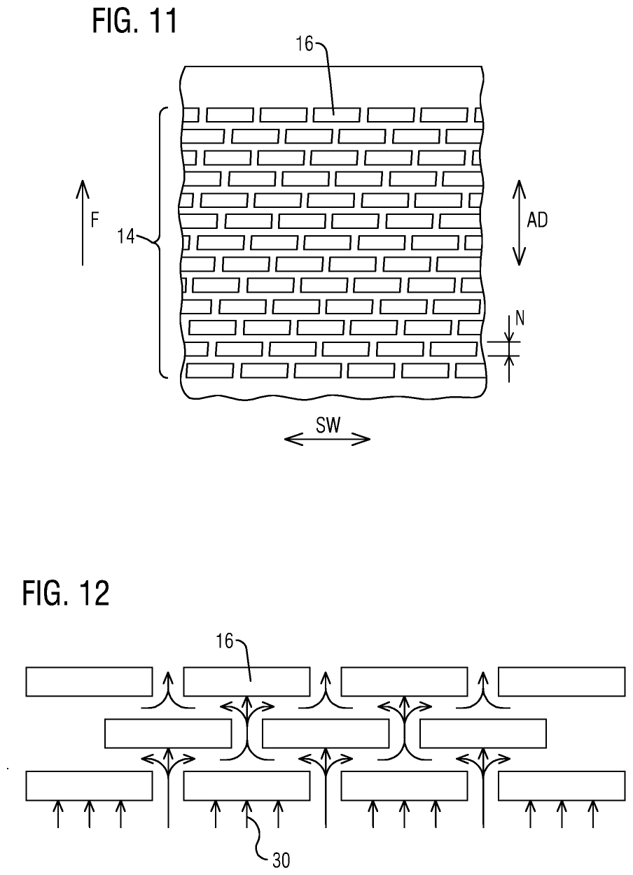

FIG. 2 through FIG. 11 show various examples of the pin fin pattern 14 that is created by the plurality of elements 16 that may be used within embodiments of the present invention. Each element 16 within the pin fin pattern 14 may be the same as any other element 16 within that pin fin pattern 14. Elements 16 of the plurality of elements 16 can be continuous, continuous as an alternating direction pattern as shown in FIG. 7, or using different elements 16 to complete the pin fin pattern 14. The plurality of elements 16 is placed span-wise in columns together aligned in a series of rows. The number of rows N is at least four. An example is shown in FIG. 11 with thirteen rows N however, there is the ability to include more rows N in the embodiments. The plurality of elements 16 is placed across an interior surface of an outer wall of the airfoil 10. The plurality of elements 16 creates the pin fin pattern 14 based on the shape of each of the plurality of elements 16 within the pin fin pattern 14.

FIG. 2 through FIG. 10 also shows the limitations of the elements 16 within each specific pin fin pattern 14. As mentioned above, the number of rows N is one limitation of the specific pin fin pattern 14. Each element 16 of the plurality of elements 16 are each a specific shape that are, in a pin fin pattern 14, put together in a tightly packed configuration in order to achieve operational efficiency. Each element 16 includes an inner length L_{C} between an inner top edge 38 and an inner bottom edge 40. The inner length Lc being the length of an individual element 16. Each element 16 also includes an inner width w between an inner left edge 34 and an inner right edge 36. The inner width w being the width of an individual element 16. Within the pin fin pattern 14 various lengths are set to make the pattern consistent with a high aspect ratio. The plurality of elements 16 includes a pin fin pattern length that extends from the inner top edge 38 of one element to the inner top edge 38 of the next element within a column. The pin fin pattern length is designated as Y. The plurality of elements 16 includes a pin fin pattern width that extends from the inner left edge 34 of one element to the inner left edge 34 of an element 16 in the next row. The pin fin pattern width is designated as X. The plurality of elements 16 extends lengthwise in a span-wise direction SW along the airfoil 10 and extends widthwise in an axial direction AD.

Within each specific pattern for each embodiment, limitations of these variables may be made in order to provide high pressure drops and heat transfer. For each pin fin pattern 14, the aspect ratio of L_{c}/w is greater than or equal to 2:1. For each pin fin pattern 14, the ratio of Y/L_{c} is equal to or less than 2:1. For each pin fin pattern 14, the ratio of X/w is equal to or less than 4:1. FIG. 11 is another example of the highly packed plurality of elements where N equals 13 of the rows of plurality of elements across an interior surface of an airfoil 10. Corners 46 of each of the elements 16 have diameters that may include limitations as well. There can be a range from a zero radius corner, to circular arcs with radius equaling w/2 along the corners 46 of each element 16. For example, an embodiment may have elements 16 with rectangular shapes 18. The corners 46 on these rectangular shapes may have zero radius corners providing as sharp of a cut as possible. In other embodiments, the corners 46 may have arcs. The radius of those arcs may have a range that may include having a radius equaling width divided by two, w/2.

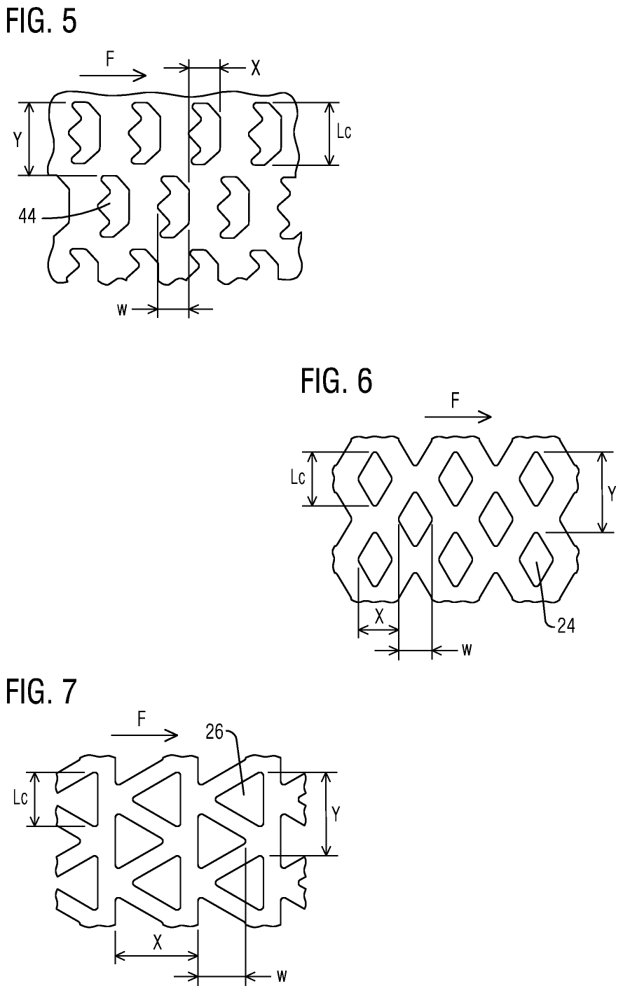

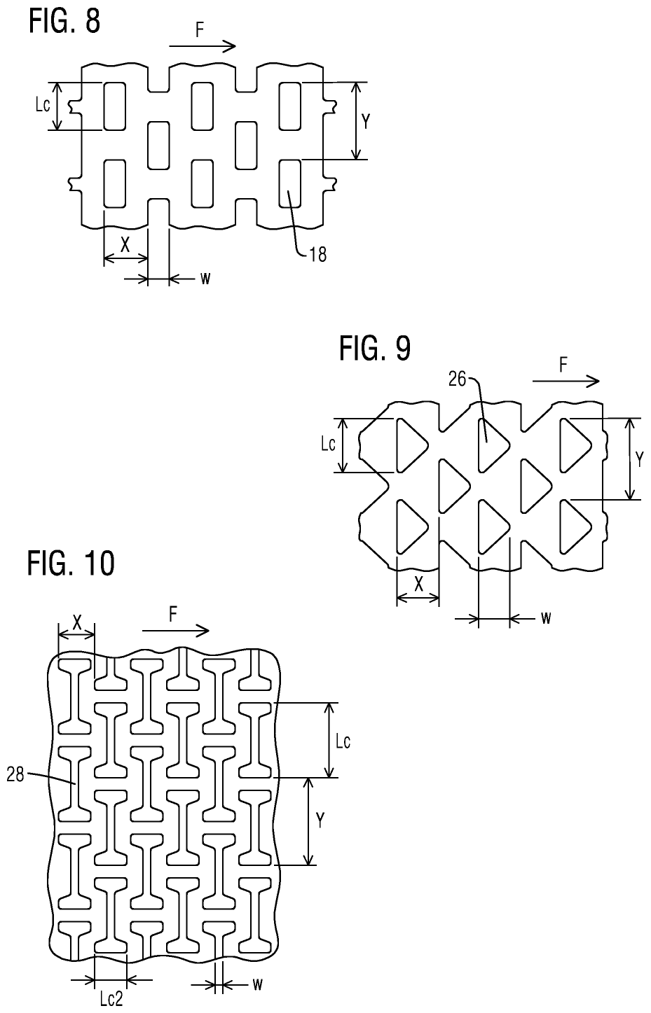

As mentioned above, FIGS. 2 through 11 show various embodiments of sections of the pin fin pattern 14. The pin fin pattern 14 can be varied in pin shape variation, Lc, L_{C2} and w, and gap separation, X and Y. FIG. 2 shows a plurality of elements 16 that include generally extended rectangular shapes 18. The longer portions of the rectangles are positioned span-wise. FIG. 3 displays a plurality of elements 16 that include generally a double chevron shape 20. The double chevron shapes 20 are sideways looking span-wise along the blade airfoil 10. FIG. 4 shows a plurality of elements 16 that include generally a modified double chevron shape 22 where a central portion extends past the width of a pair of ends on each element 16 and the end portions are smaller than the evenly spaced double chevron shapes 20 as shown in FIG. 3. Again, the modified double chevron shape 22 is positioned along its side looking span-wise along the blade. FIG. 5 shows a plurality of elements 16 that include a generally “crown” shape 44. The crown shape includes a flat surface that angles up to the sides and the opposite side includes zig-zag or crown shape. FIG. 6 shows a plurality of elements 16 that include a generally diamond shape 24. FIG. 7 shows a plurality of elements 16 that include generally triangle shapes 26 in alternating directions pointing towards and away from the main portion of the blade. FIG. 8 shows a plurality of elements 16 that include generally rectangular shapes 18. The FIG. 8 embodiment includes a smaller inner length L_{C} than as shown in FIG. 2 with the same inner width w. FIG. 9 shows a plurality of elements that include generally triangle shapes 26 with each triangle facing the same direction and with the base of each triangle shape 26 making contact with the cooling fluid first. FIG. 10 shows a plurality of elements 16 that include generally I-beam shapes 28 with the cross portions along the inner top edge and the inner bottom edge of each element 16 and a main portion that runs perpendicularly from the cross portions. For the generally I-beam shapes 28, an additional width L_{C2} is shown. The additional width L_{C2} is the width of the cross portion of the I-beam shape. The inner width w designates the width of the main portion. The FIG. 2 through FIG. 10 show the plurality of elements 16 with the flow of the cooling fluid moving from left to right. The pin fin pattern width X, pin fin pattern length Y, inner width w, inner length L_{C}, and the additional width L_{C2} all can be varied within one pin fin pattern 14 in order to optimize the pressure drop and heat transfer. The number of rows N available increases with the ratios listed above adjusted for pressure drop and heat transfer.

FIG. 12 is an example of the cooling air path as the cooling air moves through the plurality of elements 16 of the pin fin pattern 14. As is shown, there is a dynamic change in direction that allows for a high pressure drop as the cooling air is spread out along the path. Hard turns in between each of the elements 16 in the plurality of elements 16 increases the pressure drops as the flow of cooling air 30 moves within the pin fin pattern 14. The smaller the spacing between each of the elements 16 within the plurality of elements 16 i.e. X and Y, allows for a greater ability to increase the pressure drop as the cooling air flows through the plurality of elements 16 of the pin fin pattern 14. The spacing between the elements 16 of the plurality of elements 16 and the sharpness of corners of each element 16 cannot be achieved with conventional casting methods. The turbine element may be manufactured by casting through a manufacturing method including stack lamination with certain molding processes can be used as a casting process that may allow for the detail required for embodiments of the present invention. Selective Laser Melting (SLM) is another example of a manufacturing method. The technology also allows for the detail within the individual elements 16 within the plurality of elements 16. The spacing in between each element 16 can be measured in millimeters.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof

What is claimed is:

1. A turbine element comprising:
a generally elongated airfoil (10) having a leading edge and a trailing edge (12) connected to a pressure side and a suction side defining an outer wall, and a cooling circuit (32), wherein the cooling circuit (32) comprises:
a plurality of elements (16) radially placed in columns together aligned in a series of rows (N) of at least four rows (N) across an interior surface of the outer wall of the airfoil (10), creating a pin fin pattern (14) based on the shape of each of the plurality of elements (16), wherein each element comprises:
an inner length (Lc) between an inner top edge (38) and an inner bottom edge (40), an inner width (w) between an inner left edge (34) and an inner right edge (36),
wherein the pin fin pattern (14) includes pin fin pattern lengths (Y) that extend from the inner top edge (38) of one element to the inner top edge of the next element within a column, and pin fin pattern widths (X) that extend from the inner left edge of one element (16) to the inner left edge of an element (16) in the next row,
wherein the plurality of elements (16) extend lengthwise in a span-wise direction along the airfoil (10) and extend widthwise in an axial direction,
wherein the aspect ratio of inner length (Lc) over the inner width (w) of each element (16) is equal to or greater than 2:1,
wherein the ratio of pin fin pattern lengths (Y) over the inner length (Lc) is equal to or less than 2:1,
wherein the ratio of pin fin pattern widths (X) over the inner width (w) is equal to or less than 4:1.

2. The turbine element according to claim 1, wherein the plurality of elements (16) comprises generally extended rectangle shapes (18).

3. The turbine element according to claim 1, wherein the plurality of elements (16) comprises generally double chevron shapes (20).

4. The turbine element according to claim 1, wherein the plurality of elements (16) comprises generally modified double chevron shapes (22).

5. The turbine element according to claim 1, wherein the plurality of elements (16) comprises generally diamond shapes (24).

6. The turbine element according to claim 1, wherein the plurality of elements (16) comprises generally triangle shapes (26).

7. The turbine element according to claim 1, wherein the plurality of elements (16) comprises generally I-beam shapes (28).

8. The turbine element according to claim 1, wherein the plurality of elements (16) comprises generally crown shapes (44).

9. The turbine element according to claim 1, wherein the plurality of elements (16) are located along a trailing edge wall along the trailing edge (12) and extending from an airfoil cavity (42) to an interior surface of the outer wall.
